(19) United States
(12) Patent Application Publication
(10) Pub. No.: US 2018/0311893 A1
(43) Pub. Date: Nov. 1, 2018

(54) ADDITIVE PRINTING APPARATUS AND METHOD EMPLOYING LIQUID BRIDGE

(71) Applicants: Jae-Won CHOI, Copley, OH (US); Yang H. YUN, Fairlawn, OH (US)

(72) Inventors: Jae-Won CHOI, Copley, OH (US); Yang H. YUN, Fairlawn, OH (US)

(21) Appl. No.: 15/770,592

(22) PCT Filed: Oct. 28, 2016
(86) PCT No.: PCT/US2016/059350

§ 371 Date: Apr. 24, 2018

Related U.S. Application Data
(60) Provisional application No. 62/248,730, filed on Oct. 30, 2015.

(51) Int. Cl. B29C 64/20; B33Y 10/00; B33Y 30/00; B29C 64/124

(52) U.S. Cl. CPC B29C 64/20; B29C 64/124; B33Y 30/00; B33Y 10/00

(57) ABSTRACT

An additive printing apparatus includes a light transmissive substrate, a light source adapted to direct light through the light transmissive substrate, a photopolymerizable material source providing photopolymerizable material, and a fluid path from the photopolymerizable material source to a delivery position proximate the light transmissive substrate. Material is delivered through the fluid path the delivery position to form a liquid bridge of the photopolymerizable material, the liquid bridge having an area of contact with the light transmissive substrate, such that, in a method of additive printing, photopolymerizing light can be shone through the light transmissive substrate to polymerize the photopolymerizable material.

### CROSS-REFERENCE TO RELATED APPLICATIONS

This application claims the benefit of U.S. Provisional Application No. 62/248,730, filed Oct. 30, 2015, and incorporated herein by reference.

### FIELD OF THE INVENTION

The present invention generally relates to additive printing apparatus and methods. More particularly, the present invention relates to additive printing apparatus and methods employing a liquid bridge to position material for forming an additive printed product layer.

### BACKGROUND OF THE INVENTION

Current technology for microstereolithography (μSL) employs a vat to provide the polymer, photoinitiator, and additives to create 3D microstructures using photopolymerization (Choi et al., Design of Microstereolithography System Based on Dynamic Image Projection for Fabrication of Three-Dimensional Microstructures, Journal of Mechanical Science and Technology, Vol. 20, No. 12, pages 2120-2130, 2006); Choi, et al., Cure depth control for complex 3D microstructure fabrication in dynamic mask projection microstereolithography, Rapid Prototyping Journal, Volume 15, Number 1, pages 59-70, 2009a; Choi, et al., Fabrication of 3D biocompatible/biodegradable micro-scaffolds using dynamic mask projection microstereolithography, Journal of Materials Processing Technology, 209, pages 5494-5503, 2009b; Choi, et al., Combined micro and macro additive manufacturing of a swirling flow coaxial phacoemulsifier sleeve with internal micro-vanes, Biomed Microdevices, Volume 12, pages 875-886, 2010a; Choi, et al., Multi-material microstereplithography, International Journal of Advanced Manufacturing Technology, Volume 49, pages 543-551, 2010b; Lu et al., Microstereplithography and characterization of poly(propylene fumarate)-based drug-loaded microneedle arrays, Biofabrication, Volume 7 045001, pages 1-13, 2015. This process produces 3D microstructures with horizontal (x-y) resolutions of a few μm and vertical (z) resolution of tens of μm. There exist two types of μSL: scanning μSL creates each layer by systematically scanning the polymer with a laser, while projection μSL projects light to an entire cross-sectional pattern on to a resin surface. With regard to its manufacturing capabilities, for example, μSL has been used to produce micro-fluidic devices (Kang et al., Development of an Assembly-free Process Based on Virtual Environment for Fabricating 3D Microfluidic Systems Using Microstereolithography Technology, Journal of Manufacturing Science and Engineering, Volume 126, pages 766-771, 2004; Choi, et al., Combined micro and macro additive manufacturing of a swirling flow coaxial phacoemulsifier sleeve with internal micro-vanes, Biomed Microdevices, Volume 12, pages 875-886, 2010a;) and tissue engineered scaffolds (Lee et al., 3D scaffold fabrication with PPF/DEF using micro-stereolithography, Microelectronic Engineering, Volume 84, pages 1702-1705, 2007; Han et al., Projection Microfabrication of Three-Dimensional Scaffolds for Tissue Engineering, Journal of Manufacturing Science and Engingeering, Volume 130, pages 021005-1-021005-4, 2008; Choi, et al., Fabrication of 3D biocompatible/biodegradable micro-scaffolds using dynamic mask projection microstereolithography, Journal of Materials Processing Technology, 209, pages 5494-5503, 2009b. One example of a projection μSL system employs a Digital Micromirror Device (DMD Discovery™ 4100 0.95″ 1080p, Texas Instruments). The DMD plays a role in generating dynamic patterns and consists of ˜2,070,000 micro-mirrors (1,920×1,080 pixels). Each one is 13.68 μm in length and can be tilted at ±12° along the diagonal axis in which the binary image information from a computer is used to control micromirror movement and generates the desired pattern Choi, et al., Cure depth control for complex 3D microstructure fabrication in dynamic mask projection microstereolithography, Rapid Prototyping Journal, Volume 15, Number 1, pages 59-70, 2009a.

DMD-based projection stereolithography machines have been commercialized by 3D Systems and EnvisionTec, where they fast produce 3D structures with the resolution of several tens of microns. To enhance this resolution over a large area, DDM Systems developed a “Large Area Maskless Photopolymerization (LAMP)” process with the resolution of 17 μm over the large area of 24×24 inches, where the resolution is not still high enough for microstructures.

Unfortunately, μSL techniques are typically limited by over curing and the lack of depth control for curing. Furthermore, all vat systems use large amounts of a photopolymer relatively to the structure that has been created. Finally, the μSL vat systems are also limited in producing structures with large horizontal areas.

There is a need in the art for a vat-free additive printing apparatus and method. There is a need as well for vat-free additive printing apparatus and methods that are capable of manufacturing devices over several centimeters of surface area, and provide for high-resolution microstructuring without compromising the micron-level resolution.

### SUMMARY OF THE INVENTION

In a first embodiment, the present invention provides an additive printing apparatus including a light transmissive substrate; a light source adapted to direct light through the light transmissive substrate; a photopolymerizable material source providing photopolymerizable material; and a fluid path from the photopolymerizable material source to a delivery position proximate the light transmissive substrate, the fluid path allowing for delivery of the photopolymerizable material to the delivery position to form a liquid bridge of the photopolymerizable material, the liquid bridge having an area of contact with the light transmissive substrate.

In a second embodiment, the present invention provides an additive printing apparatus as in any of the forgoing embodiments, further including a carrier substrate opposed to the light transmissive substrate.

In a third embodiment, the present invention provides an additive printing apparatus as in any of the forgoing embodiments, wherein the delivery position is between the carrier substrate and the light transmissive substrate, and the liquid bridge has an area of contact with the light transmissive substrate and the carrier substrate.

In a fourth embodiment, the present invention provides an additive printing apparatus as in any of the forgoing embodiments, further comprising an additive printed layer on the carrier substrate, wherein the delivery position is between the carrier substrate and the light transmissive substrate the liquid bridge has an area of contact with the light transmissive substrate and the additive printed layer on the carrier substrate.

In a fifth embodiment, the present invention provides an additive printing apparatus as in any of the forgoing embodiments, wherein the carrier substrate and the light transmissive substrate are movable relative to one another to alter the distance between them.

In a sixth embodiment, the present invention provides an additive printing apparatus as in any of the forgoing embodiments, wherein the carrier substrate is movable, and the light transmissive substrate is stationary

In a seventh embodiment, the present invention provides an additive printing apparatus as in any of the forgoing embodiments, further comprising an additive printed layer opposed to the light transmissive substrate, the delivery position being between the additive printed layer and the light transmissive substrate

In an eighth embodiment, the present invention provides an additive printing apparatus as in any of the forgoing embodiments, wherein light source is movable in plane parallel to the plane of the light transmissive substrate so as to scan across the area of contact.

In a ninth embodiment, the present invention provides an additive printing apparatus as in any of the forgoing embodiments, wherein the light source is a scanning laser.

In a tenth embodiment, the present invention provides an additive printing apparatus as in any of the forgoing embodiments, wherein the light source is a projector.

In an eleventh embodiment, the present invention provides an additive printing apparatus as in any of the forgoing embodiments, wherein the projector is selected from a liquid crystal displays (LCDs) and a digital micromirror device

In a twelfth embodiment, the present invention provides an additive printing apparatus as in any of the forgoing embodiments, wherein the light transmissive substrate is coated with a surface energy reducing agent at the area of contact with the liquid bridge, the surface energy reducing agent reducing the bond energy between the additive printed layer and the light transmissive substrate

In a thirteenth embodiment, the present invention provides an additive printing apparatus as in any of the forgoing embodiments, wherein the bond energy between the additive printed layer and the light transmissive substrate is modified by the apparatus including at least one of the following: a surface energy increasing agent coating the carrier substrate at the area of contact with the liquid bridge, the surface energy increasing agent increasing the bond energy between the additive printed layer and the carrier substrate, and a plasma-treated surface on the carrier substrate at the area of contact with the liquid bridge, the plasma-treated surface increasing the bond energy between the additive printed layer and the carrier substrate.

In a fourteenth embodiment, the present invention provides an additive printing apparatus as in any of the forgoing embodiments, wherein the fluid path includes a delivery mechanism to advance the photopolymerizable material to the light transmissive substrate.

In a fifteenth embodiment, the present invention provides an additive printing apparatus as in any of the forgoing embodiments, wherein the delivery mechanism is selected from pumps and syringes.

In a sixteenth embodiment, the present invention provides an additive printing apparatus as in any of the forgoing embodiments, further comprising a ventilated enclosure enclosing the light source and the light transmissive substrate and the liquid bridge to avoid contamination.

In a seventeenth embodiment, the present invention provides an additive printing apparatus as in any of the forgoing embodiments, further comprising a filter associated with the ventilated enclosure to filter air drawn into the ventilated enclosure

In an eighteenth embodiment, the present invention provides an additive printing apparatus as in any of the forgoing embodiments, wherein the photopolymerizable material has a viscosity of greater than 5,000 cP

In a nineteenth embodiment, the present invention provides an additive printing apparatus as in any of the forgoing embodiments, wherein the apparatus is vatless, such that the carrier substrate is not associated with a vat of additive printing material

In a twentieth embodiment, the present invention provides an additive printing apparatus as in any of the forgoing embodiments, wherein the photopolymerizable material source is one of a plurality of photopolymerizable material sources, all the plurality of photopolymerizable material sources being deliverable to the delivery position.

In a twenty-first embodiment, the present invention provides an additive printing apparatus as in any of the forgoing embodiments, wherein each one of the plurality of photopolymerizable material sources includes a unique delivery mechanism to advance the photopolymerizable material to the light transmissive substrate

In a twenty-second embodiment, the present invention provides an additive printing apparatus as in any of the forgoing embodiments, further comprising a vacuum system for withdrawing photopolymerizable material from the delivery position to allow for introduction of a first material to the delivery position and removal thereof from the delivery position for subsequent introduction of a second material to the delivery position.

In a twenty-third embodiment, the present invention provides an additive printing apparatus as in any of the forgoing embodiments, further comprising a mixing chamber along the fluid path, wherein two of the plurality of photopolymerizable material sources feed to the mixing chamber

In a twenty-fourth embodiment, the present invention provides a method of additive printing comprising the steps of: (a) forming a liquid bridge having an area of contact with a light transmissive substrate, the liquid bridge being formed of photopolymerizable material; (b) polymerizing the photopolymerizable material of step (a) by directing light through the light transmissive substrate to polymerize the photopolymerizable material at at least a portion of the area of contact with the light transmissive substrate, the step of polymerizing creating an additive printed layer.

In a twenty-fifth embodiment, the present invention provides an additive printing apparatus as in any of the forgoing embodiments, wherein the step (a) of forming a liquid bridge includes delivering the photopolymerizable material from a photopolymerizable material source to a delivery position proximate the light transmissive substrate and making contact between the light transmissive substrate and the photopolymerizable material at the delivery position.

In a twenty-sixth embodiment, the present invention provides an additive printing apparatus as in any of the forgoing embodiments, wherein a carrier substrate is provided proximate the delivery position, and the liquid bridge is formed between the carrier substrate and the light transmissive substrate.

In a twenty-seventh embodiment, the present invention provides an additive printing apparatus as in any of the forgoing embodiments, further comprising the steps of: (c) moving the additive printed layer of step (b) a distance away from the light transmissive substrate such that a liquid bridge of the photopolymerizable material is maintained between the carrier substrate and the light transmissive substrate, and an area of contact is maintained with the light transmissive substrate; and (d) polymerizing the photopolymerizable material of step (c) by directing light through the light transmissive substrate to polymerize the photopolymerizable material at at least a portion of the area of contact with the light transmissive substrate, the step of polymerizing creating a second additive printed layer on top of the additive printed layer of step (b).

In a twenty-eighth embodiment, the present invention provides an additive printing apparatus as in any of the forgoing embodiments, further comprising the steps of: (c) moving the additive printed layer of step (b) a distance away from the light transmissive substrate; (d) withdrawing the liquid bridge of photopolymerizable material, and, after the step of withdrawing, (e) forming a second liquid bridge between the carrier substrate and the light transmissive substrate, the second liquid bridge surrounding the additive printed layer, and defining an area of contact with the light transmissive substrate, the second liquid bridge being formed of a photpolymerizable material that is the same or different from the photopolymerizable material of step (a); and (f) polymerizing the photopolymerizable material of step (e) by directing light through the light transmissive substrate to polymerize the photopolymerizable material at at least a portion of the area of contact with the light transmissive substrate, the step of polymerizing creating a second additive printed layer on top of the additive printed layer of step (b).

In a twenty-ninth embodiment, the present invention provides an additive printing apparatus as in any of the forgoing embodiments, further comprising the steps of: (c) moving the additive printed layer of step (b) a distance away from the light transmissive substrate; (d) withdrawing the liquid bridge of photopolymerizable material, and, after the step of withdrawing, (e) forming a second liquid bridge between the first additive printed layer and the light transmissive substrate, the second liquid bridge defining an area of contact with the light transmissive substrate, the second liquid bridge being formed of a photpolymerizable material that is the same or different from the photopolymerizable material of step (a); and (0 polymerizing the photopolymerizable material of step (e) by directing light through the light transmissive substrate to polymerize the photopolymerizable material at at least a portion of the area of contact with the light transmissive substrate, the step of polymerizing creating a second additive printed layer on top of the additive printed layer of step (b).

In a thirtieth embodiment, the present invention provides an additive printing apparatus as in any of the forgoing embodiments wherein the step of forming a bridge include continuously moving the additive printed layer of step (b) a distance away from the light transmissive substrate such that a liquid bridge of the photopolymerizable material is maintained between the carrier substrate and the light transmissive substrate, and an area of contact is maintained with the light transmissive substrate; and, wherein the step of polymerizing is a step of continuously polymerizing the photopolymerizable material during step (c) by directing light through the light transmissive substrate to polymerize the photopolymerizable material at at least a portion of the area of contact with the light transmissive substrate.

In a thirty-first embodiment, the present invention provides an additive printing apparatus as in any of the forgoing embodiments, wherein the photopolymerizable material is selected from the group consisting of monomer, oligomer, pre-polymer, polymer melts, and inorganic powders such as ceramic, and porcelain.

In a thirty-second embodiment, the present invention provides an additive printing apparatus as in any of the forgoing embodiments, wherein the area of contact is devoid of oxygen such that polymerization occurs without the presence of oxygen.

### BRIEF DESCRIPTION OF THE DRAWINGS

FIG. 1 is a schematic side elevational view of an additive printing apparatus in accordance with this invention;

FIG. 2 is a cross-sectional view taken along the line 2-2 in FIG. 1, showing an area of contact between a liquid bridge and a light transmissive substrate;

FIG. 3 is a schematic side elevational view of an additive printing apparatus in accordance with this invention, showing the formation of a first additive printed layer, and the maintenance or creation of a liquid bridge therearound;

FIG. 4 is a schematic side elevational view of an additive printing apparatus in accordance with this invention, showing the ability to create desired additive printed structures wholly within a liquid bridge;

FIG. 5 is a schematic side elevational view of an additive printing apparatus in accordance with this invention, showing the formation of a first additive printed layer, and the formation of a liquid bridge between that first additive printed layer and a light transmissive substrate;

FIG. 6 is a schematic side elevational view of an additive printing apparatus in accordance with this invention, showing the use of various photopolymerizable materials sources and the option of mixing components that are advisable to first keep separated before introduction to form a liquid bridge.

### DETAILED DESCRIPTION OF ILLUSTRATIVE EMBODIMENTS

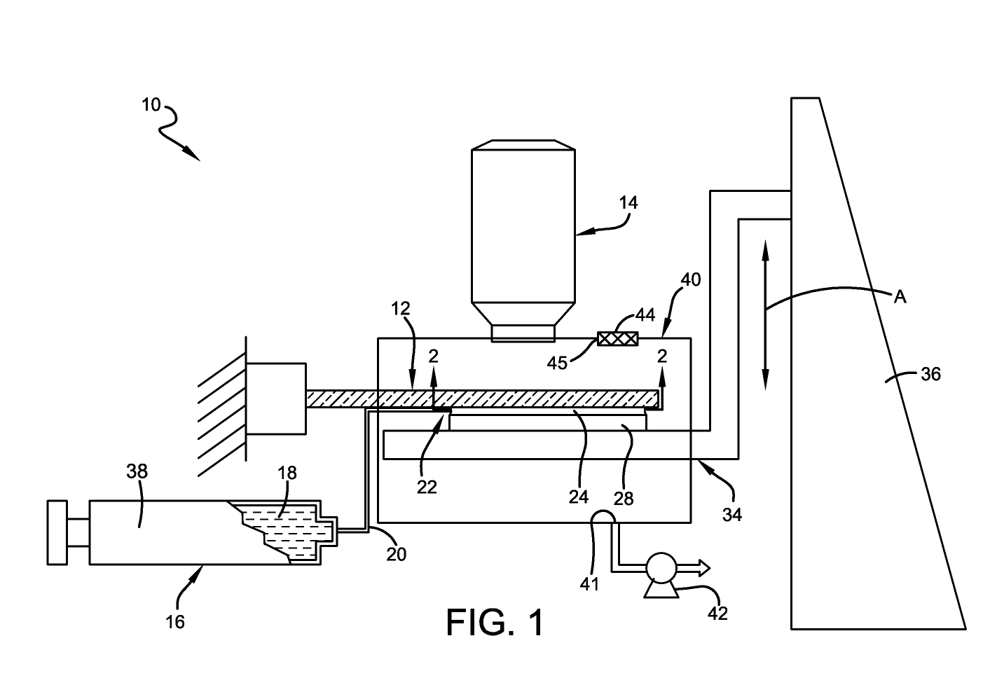

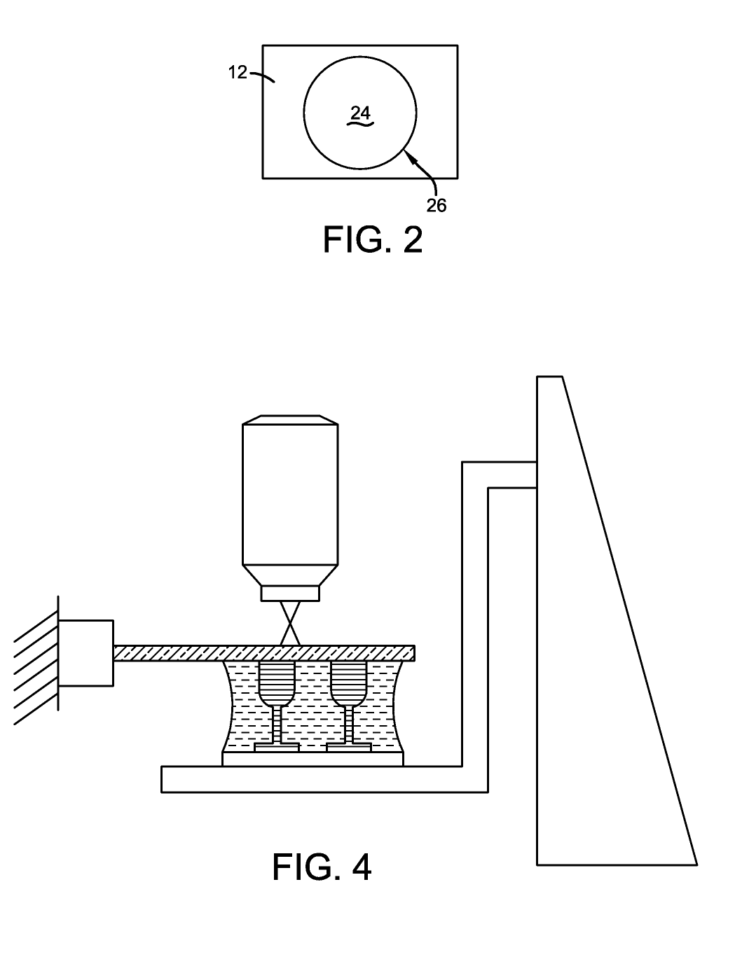

Referring now to FIG. 1, an additive printing apparatus in accordance with this invention is shown and designated by the numeral 10. The additive printing apparatus 10 includes a light transmissive substrate 12 and a light source 14 adapted to direct light through the light transmissive substrate 12. A photopolymerizable material source 16 supplies a photopolymerizable material 18 for delivery along a fluid path 20 to a delivery position 22 proximate the light transmissive substrate 12. The photopolymerizable material 18 forms a liquid bridge 24 (also known as a capillary bridge or liquid capillary bridge) with the light transmissive substrate 12. As seen in the cross section of FIG. 2, the liquid bridge 24 defines an area of contact 26 with the light transmissive substrate 12. With this minimal structure, additive printing can be achieved by transmitting light through the light transmissive substrate 12 to initiate polymerization of at least a portion of the polymerizable material 20 of the liquid bridge 24.

The area of contact (26 in FIG. 2) of the liquid bridge at the contact with the light transmissive substrate can be circular, as shown, and this is a general shape that is formed naturally by a liquid bridge. Alternatively, a polygonal shape can be achieved either by providing a substrate with polygonal surface area or by treating only a polygonal area to have different surface energy (see below regarding surface energy manipulation). Notably, in some embodiments, the light transmissive substrate is very smooth at the area of contact with the liquid bridge, and this results in a highly polished surface for the additive printed layer formed in contact with the light transmissive substrate.

In particular embodiments, a carrier substrate 28 is opposite the light transmissive substrate 12 such that the light transmissive substrate 12 is positioned between the light source 14 and the carrier substrate 28. In many embodiments, in a first step, the delivery position 22 is positioned between the carrier substrate 28 and the light transmissive substrate 12 such that the liquid bridge 24 is formed between these two substrates and defines an area of contact 26 with the light transmissive substrate 12 as well as an area of contact with the carrier substrate 28. With this structure, light can then be transmitted through the light transmissive substrate 12 to polymerize at least a portion of the polymerizable material 18 of the liquid bridge 24 to thereby provide an additive printed layer on the carrier substrate 28.

In some embodiments, the photopolymerizable material is selected from the group consisting of monomer, oligomer, pre-polymer, polymer melts, and inorganic powders such as ceramic, and porcelain. In some embodiments, the photopolymerizable material includes nanoparticles such as carbon nanotubes, carbon blacks, and other metal particles (silver, gold, copper, etc.).

In some embodiments, the carrier substrate 28 is moveable away from and closer to the light transmissive substrate 12. In FIG. 1, this is shown by arrow A as the ability to move downward and upward relative to a light transmissive substrate 12. In this embodiment shown, the light source 14 is positioned above the carrier substrate 28, but it will be appreciated that orientations could be altered, particularly with, in some embodiments, a 180 degree reversal of the orientation of these elements.

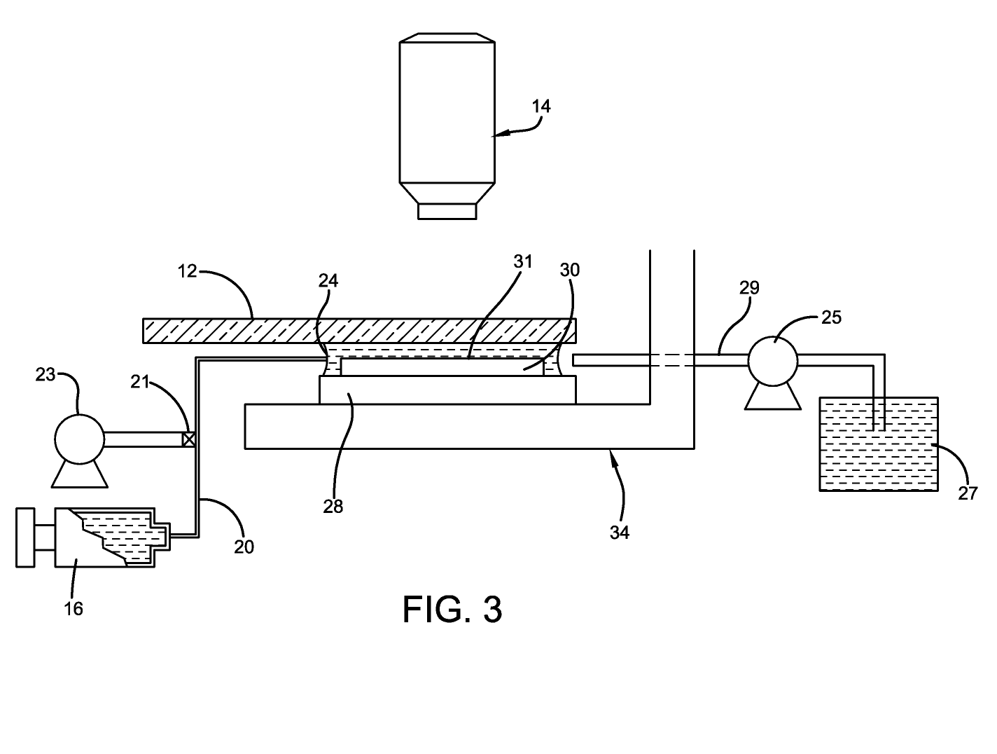

As seen in FIG. 3 after formation of an additive printed layer 30 on the carrier substrate, the carrier substrate 28 would be moved downwardly, thus drawing the additive printing layer 30 with it. More particularly, the polymerization of the polymerizable material occurs between the carrier substrate 28 and the light transmissive substrate 12, and the additive printed layer 30 created thereby must be distanced from the light transmissive substrate 12 to create a subsequent additive printed layer. This can be achieved in a number of ways.

As seen in FIG. 3, it is possible that the carrier substrate 28 can be moved away from the light transmissive substrate 12 to define a distance between the top surface 31 of the additive printed layer 30 and the bottom surface of the light transmissive substrate 12, and, yet, the liquid bridge 24 provided for formation of the additive printed layer 30 will remain, though its dimensions slightly changed in light of the movement of the carrier substrate 28. It is also possible to add additional material through fluid path 20 or other paths provided (disclosed more particularly below), in order to increase the volume of the liquid bridge 24 as needed in light of the creation of additive printed layers and the movement of each subsequent layer away from the light transmissive substrate 12. With the liquid bridge 24 maintained, a second additive printed layer can be formed on top of the additive printed layer 30, again by initiating polymerization with the light source 14. In some embodiments, this process is repeated, wherein the original liquid bridge is maintained, either by being originally formed of a suitable volume for maintaining the bridge during the printing of all desired layers or by the addition of materials as mentioned above, in order to create the desired additive printed product wholly inside of the liquid bridge. This is generally shown in FIG. 4, wherein the wine glass-like structures are shown formed wholly within a liquid bridge.

In some embodiments, it is also possible that a photopolymerizable material forming a liquid bridge for the creation of a particular additive printed layer could be removed, as generally represented by the valve 21 and the pump 23 (FIG. 3) communicating with the fluid path 20, and a new liquid bridge could be formed surrounding the prior additive printed layers. This concept of employing a pump and valve or other similar functioning elements for similar purpose can be applied to any and all embodiments herein. In some embodiments, it is also possible that a photopolymerizable material forming a liquid bridge for the creation of a particular additive printed layer could be rinsed away, as generally represented by the pump 25 advancing a rinse fluid 27 through a rinse fluid path 29 delivering rinse fluid to the location of the liquid bridge formation. This concept of delivering a rinse fluid can be applied to any and all embodiments herein.

Indeed, the listing of a particular feature in association with a particular figure/embodiment should not be interpreted as an indication that such feature must only be associated with such an embodiment, especially where the ability to incorporate certain features into different embodiments is readily apparent. The summary of the invention set forth herein provides a broad, but non-limiting, overview of the ability to combine various features of the present invention.

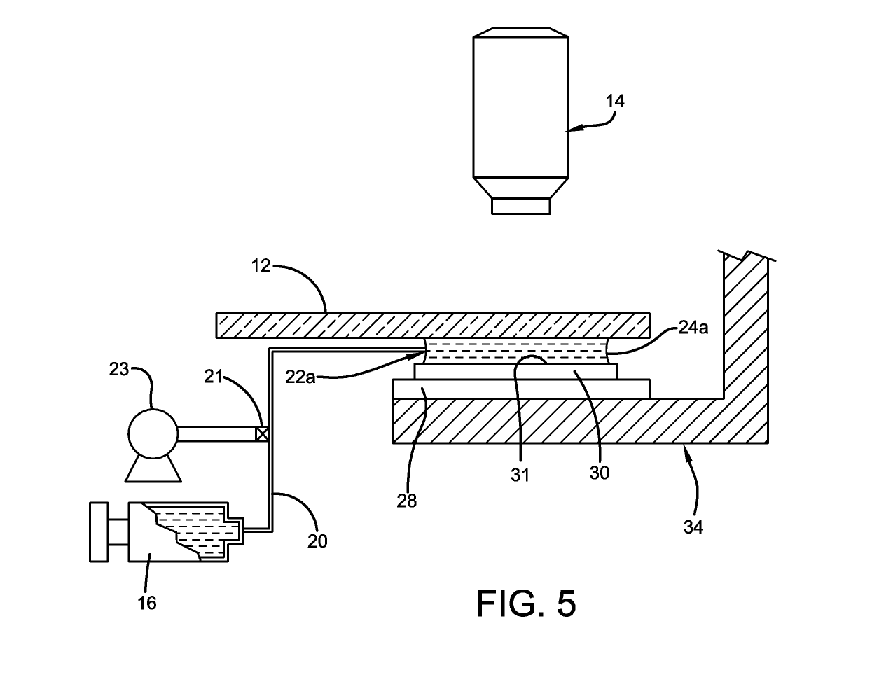

Referring now to FIG. 5, in other embodiments, after forming the additive printed layer 30 within a liquid bridge and distancing its top surface 31 from the light transmissive substrate 12, the original liquid bridge is removed (e.g., through valve 21 and pump 23), and a new delivery position 22a is defined between the additive printed layer 30 and the light transmissive substrate 12, and this liquid bridge 24a has an area of contact with the light transmissive substrate 12 and an area of contact with the additive printed layer 30, substantially as shown with respect to the exemplary showing of an area of contact in FIG. 2. With this structure, light from light source 14 can be transmitted through light transmissive substrate 12 to polymerize and form a second additive printed layer on top of the prior additive printed layer 30. A rinsing system as described with respect to FIG. 3 could also be employed.

In some embodiments, the carrier substrate 28 can be placed on a carriage platform 34 that is associated with an appropriate apparatus 36 for moving the carriage platform 34 (and thus the carrier substrate 28) closer to and farther away from the light transmissive substrate 12. There are a multitude of options for the apparatus 36. Additionally, it is sufficient that the carrier substrate 28 and the light transmissive substrate 12 be movable relative to one another to alter the distance between them and/or change their relative positions laterally, and thus one or the other of these elements (or both) could be made movable relative to the other. In the embodiment shown, the carrier substrate is movable, and the light transmissive substrate 12 is stationary.

In some embodiments, the liquid bridge can be moved with respect to its position on the carrier substrate by moving the light transmissive substrate, particularly when the surface tension between the photopolymerizable material and the light transmissive substrate is high or relatively higher than the surface tension between the photopolymerizable material and the carrier substrate. In some embodiments, the liquid bridge can be moved with respect to its position on the light transmissive substrate by moving the carrier substrate, particularly when the surface tension between the photopolymerizable material and the carrier substrate is high or relatively higher than the surface tension between the photopolymerizable material and the light transmissive substrate.

In some embodiments, the light source 14 is a scanning light source that serves to scan a polymerizing light across and through an area of the light transmissive substrate 12 to polymerize that area (actually “volume” in that there is a thickness dimension as well) of the liquid bridge. Appropriate X-Y translation stages can be employed. Other options include using scanning mirrors (i.e. galvanometric mirrors) to scan a polymerizing light across the desired surface area. Other scanning light sources can include lasers.

In some embodiments, the light source 14 is a projector-type light source that simply projects a desired shape onto the photopolymerizable material in order to polymerize and cure that shape into an additive printed layer. Suitable non-limiting examples of apparatus to serve as light source 14 include liquid crystal displays (LCDs) and digital micromirror devices (DMDs) and spatial light modulators.

In some embodiments, a continuous projection is employed, and the carrier substrate and light transmissive substrate are moved relatively to each other continuously and at an appropriately slow speed while a modulated (changing) light pattern is projected. That is, there is no stopping to polymerize a given additive printed layer. Instead, the distance between the carrier substrate and light transmissive substrate gradually increases, and photopolymerizable material is continuously delivered (if necessary), while the projection pattern changes as needed to create the desired additive printed product. The continuous relative movement between the light transmissive substrate and the carrier substrate continuously provides additional photopolymerizable material between those two substates. This has an advantage of a producing at high speeds, and avoids the stair-type structure inherent in stop-and-print-type additive printing methods that print a first layer, move the first layer to provide distance for polymerizing a second layer, and then print that second layer on the first.

In some embodiments, the light transmissive substrate 12 is coated with a surface energy reducing agent at the area of contact with the liquid bridge or liquid bridges formed during the additive printed process. The surface energy reducing agent is provided to reduce the bond energy between the polymer created by the photopolymerization of the photopolymerizable material such that the additive printed layer formed through such polymerization will more readily separate from the light transmissive substrate and will not stick thereto. Appropriate selection of surface energy reducing agents can be chosen based upon the polymer or polymers being formed in a given additive printed layer. Suitable, non-limiting surface energy reducing agents include fluorinated alcohols, silicone polyethers, and silicone modified polyacrylates.

While separation of the printed layers from the light transmissive substrate is beneficial, it will also be appreciated that, in some embodiments, it is advisable to increase the bond energy between the carrier substrate and the additive printed layer formed thereon in an initial printing step. This will ensure that the additive printed layer on the carrier substrate will move with the carrier substrate without a tendency to separate therefrom. Thus, in some embodiments, the carrier substrate is coated with a surface energy increasing agent at the area of contact with the liquid bridge, with the surface energy increasing agent increasing the bond energy between the carrier substrate and the polymer formed upon photo polymerization of the photopolymerizable material (i.e., the additive printed layer).

Alternatively, the carrier substrate or the light transmissive substrate or both may be plasma-treated at the area of contact with the liquid bridge. It will be appreciated that the plasma-treated surface can serve to increase or decrease the bond energy between the additive printed layer and the substrate(s) or between the additive printed layer and the substrate(s).

With reference back to FIG. 1, it can be seen that a delivery mechanism 38 can be employed to deliver the photopolymerizable material 18 from the photopolymerizable material 16. A multitude of delivery mechanisms will be apparent to those of ordinary skill in the art. Suitable, non-limiting examples include pumps and syringes. In some embodiments, the delivery mechanism is a micro pump, meaning a pump having a high precision servo or stepping motor for delivering product on the order of from 0.1 μL or more. In some embodiments, the delivery mechanism is a syringe wherein a stepper motor advances or withdraws the plunger to selectively deliver and withdrawal material.

With further reference to FIG. 1, it can be seen that the light transmissive substrate and the liquid bridge can be enclosed in order to avoid contamination at the area where additive printing takes place and an optional ventilated enclosure 40 is shown enclosing the light source 14, the light transmissive substrate 12, the liquid bridge 24, the carrier substrate 28, and portions of the carrier platform 34, and includes a vacuum source 42 for venting. A filter 44 is positioned at an inlet 45, and a vacuum is drawn with vacuum source 42 at an opposed side of the enclosure 40 such that air is draw into the enclosure 40 through the filter 44, and drawn out at outlet 41 feeding to the vacuum source 42.

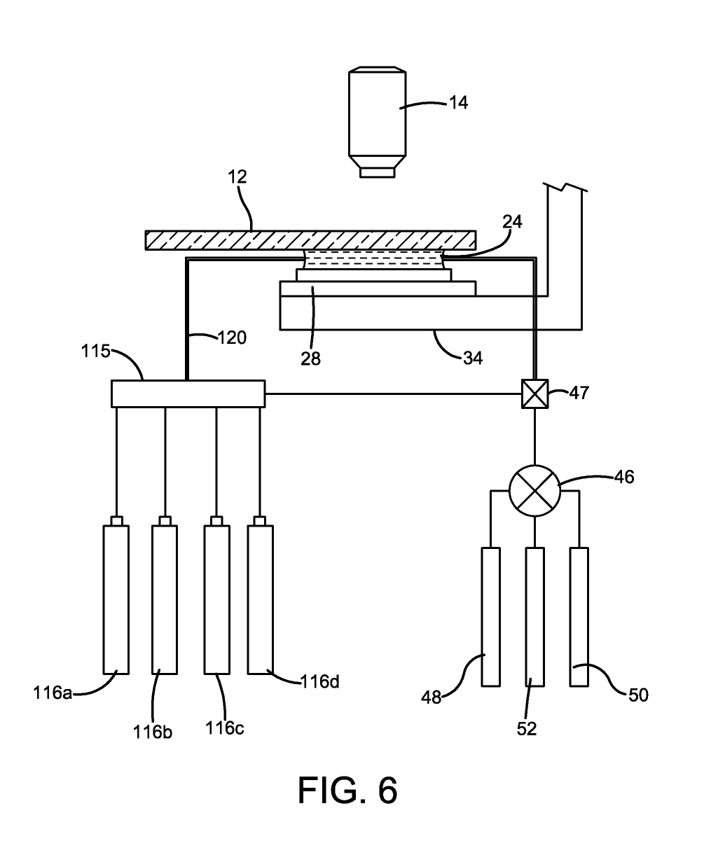

With reference to FIG. 6, it can be seen that a multitude of photopolymerizable materials might be provided, as represented at various photopolymerizable materials sources 116a, 116b, 116c, 116d. In FIG. 6, a multitude of materials are provided, which all feed to a common delivery path 120. A manifold 115 may be employed in some embodiments. Though not shown, each source 116a, etc., might provide its own delivery path to a delivery position substantially as already described for example with respect to delivery position 22. Though not shown, in this embodiment, a liquid bridge removal system and/or a rinse system could also be employed (see for example FIG. 3), as could the vented enclosure 40. These various delivery and removal apparatus and methods can be employed to withdraw a first photopolymerizable material in order to thereafter introduce a second photopolymerizable material, thus switching materials while minimizing the potential for contamination or otherwise having different materials interfere with the functioning of others.

With further reference to FIG. 6, an optional mixing chamber 46 could be employed to mix components that are advisable to first keep separated before introduction to form a liquid bridge. It will be appreciated that photopolymerizable materials in additive printing can include not only polymerizable components, but also auxiliary components such as solvents, photoinitiators, surface energy reducing agents, additives, and drugs, and these components could be supplied separate of the polymerizable material and mixed with the polymerizable material in the mixing chamber 46, as represented by the polymerizable material source 48, the drug source 50, and the solvent source 52. The mixed materials could be fed to the manifold 115 or directly to a delivery position, as represented by the different fluid paths extending from the mixing chamber 46, particularly at junction 47, which would be provided with appropriate valves to direct flow where desired.

In some embodiments, the apparatus is employed to print products in the micro scale. In some embodiments, resolutions in the xy plane of 10 μm or less can be achieved. In other embodiments, resolutions in the xy plane of 5 μm or less can be achieved, in other embodiments, 4 μm or less, in other embodiments, 3 μm or less, and, in yet other embodiments, 2 μm or less. This relates to the thickness of any given printed segment.

In some embodiments, a liquid bridge formed between a carrier substrate and a light transmissive substrate can be employed to form within the liquid bridge a product having height of 50 mm or less. In other embodiments, a liquid bridge formed between a carrier substrate and a light transmissive substrate can be employed to form within the liquid bridge a product having height of 30 mm or less, in other embodiments, 13 mm or less, in other embodiments, 10 mm or less, in other embodiments, 5 mm or less, in other embodiments, 2 mm or less, in other embodiments, 1 m or less, in other embodiments, 750 μm or less, in other embodiments, 500 μm or less, in other embodiments, 250 μm or less, in other embodiments, 100 μm or less, in other embodiments, 50 μm or less, in other embodiments, 25 μm or less, and, in other embodiments, 10 μm or less.

The thickness of a particular additive printed layer can be as small as 500 nm.

Notably, the present invention is devoid of the photopolymerizable material vats that are found in the prior art. Only a liquid bridge of minimal volume is necessary to print a given layer of the desired product. Additionally, the polymerization takes places at an area of contact between the liquid bridge and a light transmissive substrate such that polymerization occurs at an area devoid of oxygen. This can be additionally facilitated by use of ventilated enclosures.

Additionally, this method can be used on photopolymerizable materials having a viscosity of greater than 5,000 cP, which is typically difficult in the vat-based systems of the prior art. In some embodiments, the photopolymerizable material has a viscosity of greater than 6,000 cP, in other embodiments, 7,000 cP, in other embodiments, 8,000 cP, in other embodiments, 9,000 cP, in other embodiments, 10,000 cP, in other embodiments, 12,500 cP, in other embodiments, 15,000 cP, in other embodiments, 17,500 cP, and, in other embodiments, greater than 20,000 cP.

With the apparatuses above, novel methods of additive printing can be practiced. The present invention broadly provides a method of additives printing including the steps of forming a liquid bridge having an area of contact with a light transmissive substrate, with the liquid bridge being formed of a photopolymerizable material such that the photopolymerizable material can be polymerized by directing light through the light transmissive substrate to polymerize the photopolymerizable material at at least a portion of the area of contact with the light transmissive substrate. This polymerization step creates an additive printed layer.

As already noted, the liquid bridge is formed by delivering the photopolymerizable material to an appropriate delivery position proximate the liquid bridge. The material is either delivered to a location at which it contacts the light transmissive substrate or it is delivered proximate the light transmissive substrate, and the light transmissive substrate is brought into contact with the photopolymerizable material to create the liquid bridge and area of contact. In at least a first step, the photopolymerizable material can be delivered between a carrier substrate and the light transmissive substrate to form a liquid bridge between the two.

Upon creation of an additive printed layer, the method further includes moving the additive printed layer a distance away from the light transmissive substrate in order to perform step to create an additional additive printed layer. This second additive printed layer may be formed by maintaining the liquid bridge upon movement of the additive printed layer away from the light transmissive substrate, as noted above, or it might be created by withdrawing the material that created the initial liquid bridge and replacing it with new photopolymerizable material. The new liquid bridge might alternatively be formed between the top surface of the prior additive printed layer and the light transmissive substrate.

Thus, in some embodiments, the method further includes moving the additive printed layer a distance away from the light transmissive substrate such that a liquid bridge of the photopolymerizable material is maintained between the carrier substrate and the light transmissive substrate, and an area of contact is maintained with the light transmissive substrate; this step of moving being followed by a polymerizing step whereby light is directed through the light transmissive substrate to polymerize the photopolymerizable material at at least a portion of the area of contact with the light transmissive substrate. This polymerizing step creates a second additive printed layer on top of the first additive printed layer. Such steps can be repeated as necessary to create a desired end product.

In other embodiments, after forming a first additive printed layer, the additive printed layer is moved a distance away from the light transmissive substrate and the liquid bridge of photopolymerizable material is withdrawn. Thereafter, a second liquid bridge is formed between the carrier substrate and the light transmissive substrate, with the second liquid bridge surrounding the prior additive printed layer and defining an area of contact with the light transmissive substrate. The second liquid bridge can be formed of a photopolymerizable material that is the same or different from the photopolymerizable material used to create the prior additive printed layer. At least a portion of the photopolymerizable material forming the second liquid bridge is polymerized by directing light through the light transmissive substrate, as already described with respect to other polymerizing steps.

In yet other embodiments, the first additive printed layer is moved a distance away from the light transmissive substrate, and the liquid bridge of photopolymerizable material is withdrawn to thereafter be replaced by a photopolymerizable material forming a second liquid bridge between the prior additive printed layer and the light transmissive substrate. Again, light is transmitted through the light transmissive substrate to polymerize at least a portion of the polymerizable material of the second liquid bridge.

The present method may be employed with virtually any photopolymerizable materials currently employed or herein after created and used in additive printing techniques. The present invention does not change principles of additive printing, per se, but rather improves upon generally known additive printing techniques by beneficially employing a liquid bridge as disclosed. The full breadth of this invention is outlined in the Summary of Invention section and the claims, and the multitude of benefits of the present invention will be readily apparent to those of ordinary skill in the art.

In light of the foregoing, it should be appreciated that the present invention significantly advances the art by providing additive printing apparatuses and methods that are improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. An additive printing apparatus comprising:
a light transmissive substrate;
a light source adapted to direct light through said light transmissive substrate;
a photopolymerizable material source providing photopolymerizable material;
a fluid path from the photopolymerizable material source to a delivery position proximate said light transmissive substrate, said fluid path allowing for delivery of said photopolymerizable material to said delivery position to form a liquid bridge of said photopolymerizable material, said liquid bridge having an area of contact with said light transmissive substrate.

2. The additive printing apparatus of claim 1, further comprising a carrier substrate opposed to said light transmissive substrate.

3. The additive printing apparatus of claim 2, wherein said delivery position is between said carrier substrate and said light transmissive substrate, and said liquid bridge has an area of contact with said light transmissive substrate and said carrier substrate.

4. The additive printing apparatus of claim 2, further comprising an additive printed layer on said carrier substrate, wherein said delivery position is between said carrier substrate and said light transmissive substrate, and said liquid bridge has an area of contact with said light transmissive substrate and said additive printed layer on said carrier substrate.

5. The additive printing apparatus of claim 2, wherein said carrier substrate and said light transmissive substrate are movable relative to one another to alter the distance between them.

6. The additive printing apparatus of claim 1, further comprising an additive printed layer opposed to said light transmissive substrate, said delivery position being between said additive printed layer and said light transmissive substrate.

7. The additive printing apparatus of claim 1, wherein light source is movable in a plane parallel to a plane defined by the light transmissive substrate so as to scan across said area of contact.

8. The additive printing apparatus of claim 1, wherein said light transmissive substrate is coated with a surface energy reducing agent at said area of contact with said liquid bridge, said surface energy reducing agent reducing the bond energy between said additive printed layer and said light transmissive substrate.

9. The additive printing apparatus of claim 1, wherein the bond energy between said additive printed layer and said light transmissive substrate is modified by the apparatus including at least one of the following:
a. a surface energy increasing agent coating said carrier substrate at said area of contact with said liquid bridge, said surface energy increasing agent increasing the bond energy between said additive printed layer and said carrier substrate, and
b. a plasma-treated surface on said carrier substrate at said area of contact with said liquid bridge, said plasma-treated surface increasing the bond energy between said additive printed layer and said carrier substrate.

10. The additive printing apparatus of claim 1, further comprising a ventilated enclosure enclosing said light source and said light transmissive substrate and said liquid bridge to avoid contamination.

11. The additive printing apparatus of claim 1, wherein said photopolymerizable material has a viscosity of greater than 5,000 cP.

12. The additive printing apparatus of claim 1, wherein said apparatus is vatless, such that said carrier substrate is not associated with a vat of additive printing material.

13. The additive printing apparatus of claim 1, wherein said photopolymerizable material source is one of a plurality of photopolymerizable material sources, all said plurality of photopolymerizable material sources being deliverable to said delivery position.

14. The additive printing apparatus of claim 13, wherein each one of said plurality of photopolymerizable material sources includes a unique delivery mechanism to advance said photopolymerizable material to said light transmissive substrate.

15. The additive printing apparatus of claim 14, further comprising a vacuum system for withdrawing photopolymerizable material from said delivery position to allow for introduction of a first material to said delivery position and removal thereof from said delivery position for subsequent introduction of a second material to said delivery position.

16. The additive printing apparatus of claim 14, further comprising a mixing chamber along said fluid path, wherein two of said plurality of photopolymerizable material sources feed to said mixing chamber.

17. A method of additive printing comprising the steps of:
(a) forming a liquid bridge having an area of contact with a light transmissive substrate, the liquid bridge being formed of photopolymerizable material;
(b) polymerizing the photopolymerizable material of step (a) by directing light through the light transmissive substrate to polymerize the photopolymerizable material at at least a portion of the area of contact with the light transmissive substrate, said step of polymerizing creating an additive printed layer.

18. A method as in claim 17, wherein said step (a) of forming a liquid bridge includes delivering the photopolymerizable material from a photopolymerizable material source to a delivery position proximate the light transmissive substrate and making contact between the light transmissive substrate and the photopolymerizable material at the delivery position.

19. The method of claim 17, wherein a carrier substrate is provided proximate the delivery position, and the liquid bridge is formed between the carrier substrate and the light transmissive substrate.

20. The method of additive printing of claims 17, further comprising the steps of:
(c) moving the additive printed layer of step (b) a distance away from the light transmissive substrate such that a liquid bridge of the photopolymerizable material is maintained between the carrier substrate and the light transmissive substrate, and an area of contact is maintained with the light transmissive substrate; and
(d) polymerizing the photopolymerizable material of step (c) by directing light through the light transmissive substrate to polymerize the photopolymerizable material at at least a portion of the area of contact with the light transmissive substrate, said step of polymerizing creating a second additive printed layer on top of the additive printed layer of step (b).

21. The method of additive printing of claims 26, further comprising the steps of:
(c) moving the additive printed layer of step (b) a distance away from the light transmissive substrate;
(d) withdrawing the liquid bridge of photopolymerizable material, and, after said step of withdrawing
(e) forming a second liquid bridge between the carrier substrate and the light transmissive substrate, the second liquid bridge surrounding the additive printed layer, and defining an area of contact with the light transmissive substrate, the second liquid bridge being formed of a photpolymerizable material that is the same or different from the photopolymerizable material of step (a); and
(f) polymerizing the photopolymerizable material of step (e) by directing light through the light transmissive substrate to polymerize the photopolymerizable material at at least a portion of the area of contact with the light transmissive substrate, said step of polymerizing creating a second additive printed layer on top of the additive printed layer of step (b).
